(19) United States
(12) Patent Application Publication
(10) Pub. No.: US 2026/0023505 A1
(43) Pub. Date: Jan. 22, 2026

(54) PERFORMANCE MODE FOR WRITE OPERATIONS

(71) Applicant: Micron Technology, Inc., Boise, ID (US)

(72) Inventor: David Aaron PALMER, Boise, ID (US)

(21) Appl. No.: 19/212,405

(22) Filed: May 19, 2025

Related U.S. Application Data
(60) Provisional application No. 63/672,506, filed on Jul. 17, 2024.

(51) Int. Cl. G06F 3/06

(52) U.S. Cl. CPC G06F 3/0659; G06F 3/0611; G06F 3/0634; G06F 3/0679

(57) ABSTRACT

In some aspects, a memory apparatus may detect that a first one or more values of one or more performance parameters satisfy one or more thresholds. The memory apparatus may receive, from a host system, a command indicating that data is to be immediately written to a non-volatile memory location. The memory apparatus may store, based on the first one or more values satisfying the one or more thresholds, the data in a temporary storage location. The memory apparatus may transmit, to the host system, an indication that the command has been completed while the data is stored in the temporary storage location. The memory apparatus may write, based on detecting that the data is to be written from the temporary storage location to the non-volatile memory location, the data from the temporary storage location to the non-volatile memory location.

### CROSS-REFERENCE TO RELATED APPLICATION

This Patent Application claims priority to U.S. Provisional Patent Application No. 63/672,506, filed on Jul. 17, 2024, entitled “PERFORMANCE MODE FOR WRITE OPERATIONS,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to a performance mode for write operations.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

A non-volatile memory device, such as a NAND memory device, may use circuitry to enable electrically programming, erasing, and storing of data even when a power source is not supplied. Non-volatile memory devices may be used in various types of electronic devices, such as computers, mobile phones, or automobile computing systems, among other examples. A non-volatile memory device may include an array of memory cells, a page buffer, and a column decoder. In addition, the non-volatile memory device may include a control logic unit (e.g., a controller), a row decoder, or an address buffer, among other examples. The memory cell array may include memory cell strings connected to bit lines, which are extended in a column direction.

A memory cell, which may be referred to as a “cell” or a “data cell,” of a non-volatile memory device may include a current path formed between a source and a drain on a semiconductor substrate. The memory cell may further include a floating gate and a control gate formed between insulating layers on the semiconductor substrate. A programming operation (sometimes called a write operation) of the memory cell is generally accomplished by grounding the source and the drain areas of the memory cell and the semiconductor substrate of a bulk area, and applying a high positive voltage, which may be referred to as a “program voltage,” a “programming power voltage,” or “VPP,” to a control gate to generate Fowler-Nordheim tunneling (referred to as “F-N tunneling”) between a floating gate and the semiconductor substrate. When F-N tunneling is occurring, electrons of the bulk area are accumulated on the floating gate by an electric field of VPP applied to the control gate to increase a threshold voltage of the memory cell.

### BRIEF DESCRIPTION OF THE DRAWINGS

FIG. 1 is a diagram illustrating an example system capable of operating in a performance mode for write operations.

FIGS. 2A-2C is a diagram of an example of a performance mode for write operations.

FIG. 3 is a flowchart of an example method associated with a performance mode for write operations.

FIG. 4 is a flowchart of an example method associated with a performance mode for write operations.

FIG. 5 is a flowchart of an example method associated with a performance mode for write operations.

### DETAILED DESCRIPTION

Memory apparatuses (e.g., memory devices and/or memory systems) may perform one or more operations associated with data management, which may enable data access and storage with improved speed and/or reliability, among other examples. In some examples, memory apparatuses may use a volatile write cache (e.g., a bank of internal SRAM or DRAM) to buffer write commands temporarily before data associated with the write commands is securely committed to storage media (e.g., non-volatile memory cells). Writing data to non-volatile memory cells may be associated with one or more write operations, such as block programming, wear leveling, and/or error correction, among other examples, resulting in increased latency compared to writing to the volatile write cache (e.g., the memory apparatus may use faster and/or simpler write operations to write to the volatile write cache). The buffering process may enable a memory apparatus to managing the latency associated with writing data to non-volatile memory cells.

In some examples, after data is transferred to (e.g., written to) the volatile write cache, the memory apparatus may mark the write command as completed. The memory apparatus may transmit, and a host system may receive, a notification that the write command is completed. This may enable the host system to proceed with other operations. This approach may improve performance for asynchronous write operations where the exact timing of write commitment to one or more non-volatile memory cells is not critical. However, in some examples, the host system may provide a command for which the host system requests immediate and/or guaranteed data persistence (e.g., to enable the host system to identify when and/or that data has been written to one or more non-volatile memory cells in the memory apparatus).

For example, the host system may provide a command indicating that the memory apparatus is to write data to non-volatile memory immediately (e.g., bypassing any caching mechanisms used by the memory apparatus). For example, the host system may provide a write command that includes a forced unit access (FUA) command. The FUA command may indicate that the memory apparatus is to write data indicated by the write command directly to non-volatile memory (e.g., rather than storing the data in the volatile write cache). As another example, the command may be a synchronize cache command indicating that the memory apparatus is to write all data currently stored in the volatile write cache to non-volatile memory (e.g., indicating that the memory apparatus is to flush the volatile write cache). Although these commands may enable improved data security, such as against power loss risks, the execution of the commands may introduce degraded performance by the memory apparatus. For example, the direct write-to-media requirement imposed by these commands can slow down write operations, because writing data to non-volatile memory is inherently slower than writing the data to the volatile write cache. The increased latency associated with executing the commands may block other traffic for the memory apparatus, thereby degrading overall system performance.

In some examples, a host system may overly rely on FUA commands or synchronization commands, such as when high performance is desired by the host system (e.g., during benchmarking of the memory apparatus). An overuse of these commands can degrade performance for the memory apparatus without any practical advantage (e.g., because the memory apparatus may already be writing data to non-volatile memory at a maximum speed and the FUA commands or synchronization commands may only serve to increase the latency). For example, when the data being written is not critical and could be tolerable to potential loss due to power failure (e.g., such as benchmark data) the FUA commands or cache synchronization commands may unnecessarily increase the latency for write commands executed by the memory device. As a result, in some cases, the use of FUA commands or cache synchronization commands by the host system may introduce an unnecessary bottleneck, thereby reducing ability of the memory apparatus to provide high write throughput and/or degrading the efficiency of the memory apparatus.

Some implementations described herein enable a memory apparatus to enhance performance through a temporary suspension of immediate write-to-media commands under certain operational conditions. For example, the memory apparatus may operate in a performance mode (e.g., a high-throughput mode) when performance parameters, such as the number of write commands, the data size in the command queue, and/or bandwidth utilization for write operations, among other examples satisfy one or more thresholds. While operating in the performance mode, the memory apparatus may receive one or more commands from a host system that indicate immediate writing of data to non-volatile memory (e.g., FUA commands or cache synchronization commands) and temporarily store the data in a temporary storage location (e.g., a volatile memory buffer or the volatile write cache) rather than writing the data immediately to the non-volatile memory. The memory device may transmit, and the host system may receive, an indication that the one or more commands have been executed or completed (e.g., although the actual completion of the one or more commands may deferred or delayed by the memory apparatus). In some examples, the host system may transmit, and the memory apparatus may receive, configuration information for the performance mode. For example, the host system may enable or disable the performance mode for the memory apparatus. Additionally, or alternatively, the configuration information may indicate values for respective thresholds used by the memory apparatus to determine when to enter or exit the performance mode.

After the operational conditions indicate an end to the high-demand conditions (e.g., when the performance parameters no longer satisfy the one or more thresholds), the memory apparatus may transition out of the performance mode and into a normal operation mode. The memory apparatus may write the data that was indicated by the one or more commands from the temporary storage location to a physical storage location (e.g., to non-volatile memory). This ensures data coherence, aligns a state of the data with the expectation of the host system, and/or preserves data integrity without propagation delay that would otherwise be caused by immediate writing of the data to the non-volatile memory.

By enabling the memory apparatus to perform a strategic deferment of immediate write-to-media commands during high-demand operational conditions, the memory apparatus may maintain throughput without negatively impacting data integrity and system reliability. For example, in high-demand scenarios, such as during benchmark tests where frequent FUA commands or cache synchronization commands may be common or frequency, the memory apparatus may reduce a likelihood of a bottleneck effect and may increase data throughput, thereby improving the performance of the memory apparatus. In this way, the memory apparatus may operate using improved resource utilization, thereby reducing the likelihood of unnecessary wear on the non-volatile memory and/or reducing the time associated with write operations during high-demand periods. This enables improved data throughput and/or resource management, among other examples, by the memory apparatus.

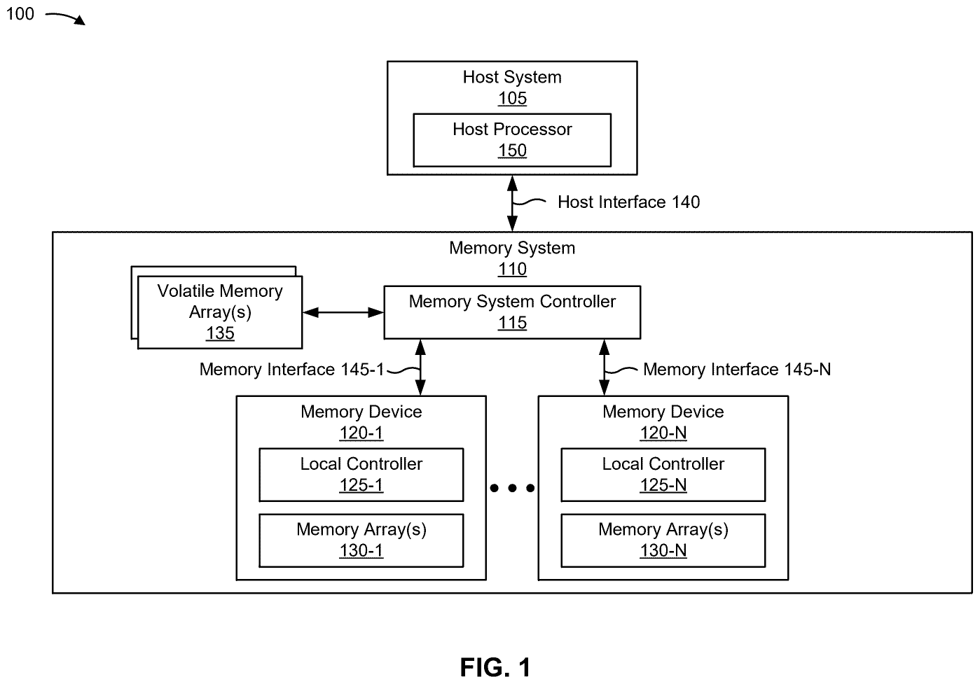

FIG. 1 is a diagram illustrating an example system 100 capable of operating in a performance mode for write operations. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N>1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IOT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some aspects, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some aspects, a memory device 120 includes a single memory array 130. In some aspects, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some aspects, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some aspects, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some aspects, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some aspects, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some aspects, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some aspects, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some aspects, execution of the set of instructions, by the controller, causes the controller, the memory system 110, and/or a memory device 120 to perform one or more operations or methods described herein. In some aspects, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some aspects, the controller may translate a host interface command (e.g., a command received from the host system 105) into a memory interface command (e.g., a command for performing an operation on a memory array 130).

In some aspects, one or more systems, devices, apparatuses, components, and/or controllers of FIG. 1 may be configured to operate, based on a first one or more values of one or more performance parameters, in a first write operation mode (e.g., a performance mode for write operations); receive, from a host system and while operating in the first write operation mode, a command indicating that data is to be immediately written to a non-volatile memory location associated with the memory apparatus; refrain, based on operating in the first write operation mode, from writing the data to the physical storage location; transmit, to the host system, an indication that the command has been completed while the data is stored in a temporary storage location; operate, after transmitting the indication that the command has been completed, in a second write operation mode; and write, while operating in the second write operation mode, the data from the temporary storage location to the non-volatile memory location.

In some implementations, one or more systems, devices, apparatuses, components, and/or controllers of FIG. 1 may be configured to transmit, to a memory apparatus, configuration information for a write performance mode of the memory apparatus, wherein the configuration information indicates one or more thresholds associated with enabling or disabling the write performance mode, and wherein the write performance mode is associated with the memory apparatus to store data in a temporary storage location of the memory apparatus when the data is associated with an immediate write indication; and selectively enable or disable, during operation of the memory apparatus, the write performance mode of the memory apparatus based on one or more operational parameters of the host system.

In some implementations, one or more systems, devices, apparatuses, components, and/or controllers of FIG. 1 may be configured to detect that a first one or more values of one or more performance parameters satisfy one or more thresholds; receive, from a host system and while the first one or more values of the one or more performance parameters satisfy the one or more thresholds, a command indicating that data is to be immediately written to a non-volatile memory location associated with the memory apparatus; store, based on the first one or more values satisfying the one or more thresholds, the data in a temporary storage location; transmit, to the host system, an indication that the command has been completed while the data is stored in the temporary storage location; detect, after transmitting the indication that the command has been completed, that the data is to be written from the temporary storage location to the non-volatile memory location; and write, based on detecting that the data is to be written from the temporary storage location to the non-volatile memory location, the data from the temporary storage location to the non-volatile memory location.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

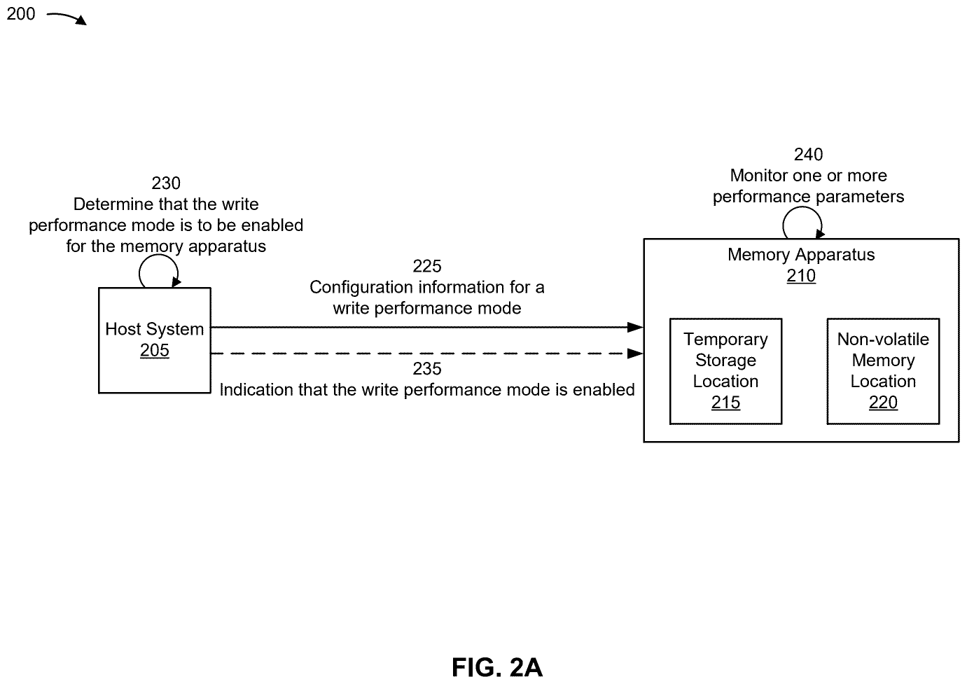

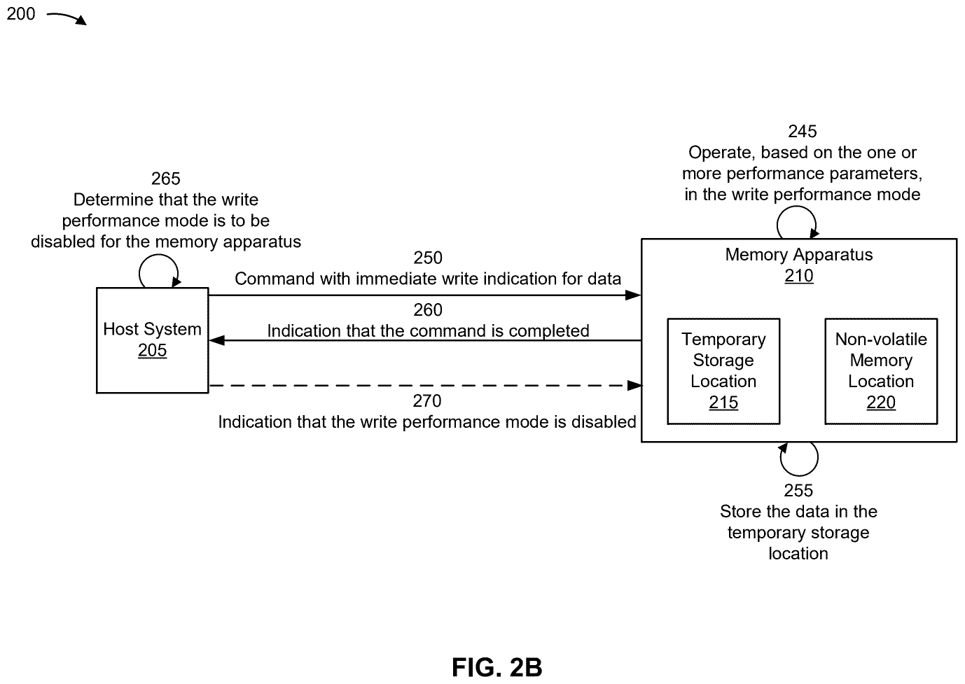

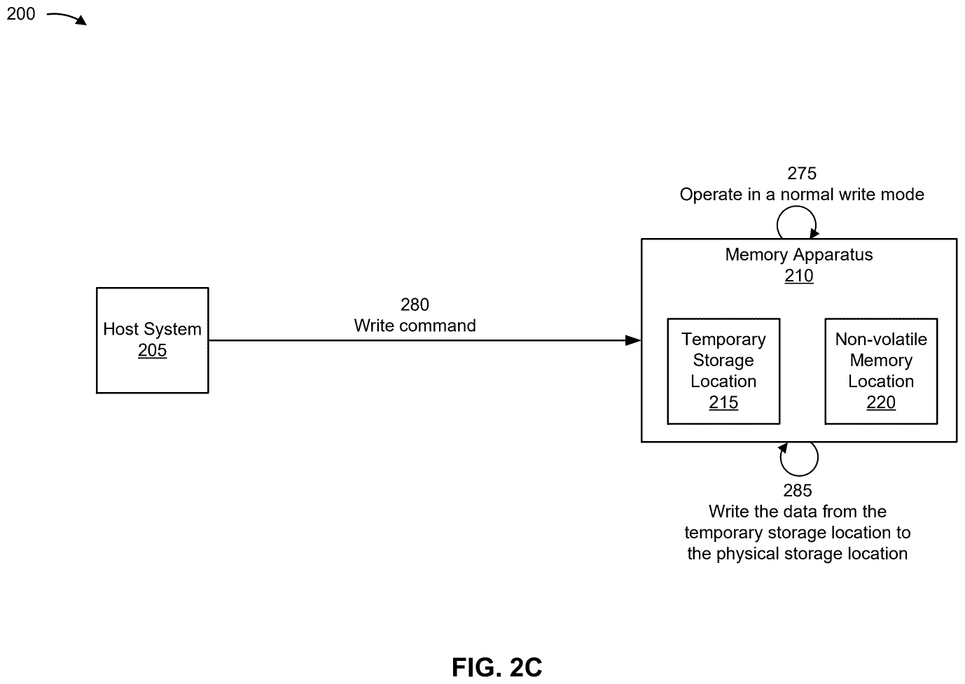

FIGS. 2A-2C is a diagram of an example 200 of a performance mode for write operations. The operations described in connection with FIGS. 2A-2C may be performed by the memory system 110 and/or one or more components of the memory system 110, such as the memory system controller 115, one or more memory devices 120, and/or one or more local controllers 125. Additionally, or alternatively, the operations described in connection with FIGS. 2A-2C may be performed by the system 100, the host system 105, one or more component of the host system 105 (e.g., the host processor 150), and/or the host interface 140.

As shown in FIGS. 2A-2C, the example 200 may include a host system 205 and a memory apparatus 210. The host system 205 may be the host system 105. The memory apparatus 210 may be, or may include, the memory system 110, one or more memory devices 120, and/or one or more controllers (e.g., the memory system controller 115 and/or one or more local controllers 125). The memory apparatus 210 may include a temporary storage location 215 and a non-volatile memory location 220 (e.g., one or more memory cells, a physical storage location, or memory media). The temporary storage location 215 may include volatile memory (e.g., one or more volatile memory arrays 135), SRAM, DRAM, a cache, and/or a buffer, among other examples. For example, the temporary storage location 215 may be a volatile write cache, as described elsewhere herein. The non-volatile memory location 220 may include storage media, non-volatile memory, one or more memory cells, and/or one or more memory arrays 130, among other examples.

As shown in FIG. 2A, and by reference number 225, the host system 205 may transmit, and the memory apparatus 210 may receive, configuration information for a write performance mode. For example, the memory apparatus 210 may obtain settings that indicate the conditions for entering the write performance mode. For example, the configuration information may include one or more thresholds associated with respective performance parameters which, when satisfied, cause or trigger the memory apparatus 210 to operate in the write performance mode. As described in more detail elsewhere herein, the write performance mode may be associated with the memory apparatus 210 deferring (e.g., temporarily) commands (e.g., from the host system 205) that indicate data is to be immediately written to the non-volatile memory location 220, such as FUA commands, and/or cache synchronization commands, among other examples. The write performance mode may be referred to herein as a “write operation mode” (e.g., a first write operation mode where a normal write operation mode is a second write operation mode).

The host system 205 may determine the configuration information. For example, the host system 205 may determine or set values for respective thresholds indicated by the configuration information. A threshold may be associated with a performance parameter. For example, a threshold may be associated with a performance parameter in a value of the performance parameter satisfying the threshold may be indicative of an event or scenario in which the memory apparatus 210 is to operate in the write performance mode. A performance parameter may include quantity of write commands in a command queue of the memory apparatus 210, a size of data associated with the write commands in the command queue, and/or a bandwidth utilization for write operations by the memory apparatus, among other examples.

The one or more thresholds may be a function of (e.g., a percentage of) a size or capacity of the command queue. For example, the command queue may be associated with an allowable quantity of commands that can be stored in the command queue at a given time. A threshold for the performance parameter of the quantity of write commands the command queue may be a function of the allowable quantity of commands (e.g., a percentage of the allowable quantity of commands), such as M percent of the allowable quantity of commands. As another example, the command queue of the memory apparatus 210 may be associated with an allowable total size of commands that can be stored in the command queue at a given time. A threshold for the performance parameter of the size of write commands the command queue may be a function of the allowable total size, such as S percent of the allowable total size.

As another example, the one or more thresholds may be a function of one or more capabilities of the memory apparatus 210. For example, the memory apparatus 210 may be associated with a supported bandwidth for write operations. The supported bandwidth may be a rate at which the memory apparatus 210 can write data to non-volatile memory, such as the non-volatile memory location 220. The supported bandwidth may be represented in terms of an amount of data (bits or bytes) that can be written per unit of time (e.g., megabytes per second or gigabits per second). A threshold for the performance parameter of the bandwidth utilization for write operations may be a function of the supported bandwidth of the memory apparatus 210, such B percent of the supported bandwidth.

In some aspects, the host system 205 may determine values for the one or more thresholds based on an analysis of historical operational data of the memory apparatus 210 and/or of the host system 205. For example, the host system 205 may evaluate historical information, such as the frequency and/or volume of write requests during periods of peak demand. The host system 205 may accordingly adjust or set the values of the one or more thresholds to reflect conditions that signify an event in which the memory apparatus 210 is to operate in the write performance mode, such as a benchmarking event or other high-demand or high-performance scenarios.

Additionally, or alternatively, the host system 205 may adjust values for one or more thresholds in real time (e.g., during runtime of the memory apparatus 210 and/or while the memory apparatus 210 is operating) based on dynamically monitored metrics. For example, the host system 205 may use a learning algorithm that processes the intensity and patterns of input/output (I/O) operations over time and modifies the criteria for performance mode activation according to identified trends and system load predictions. This may enable the host system 205 and/or the memory apparatus 210 to adapt to evolving use cases or performance requirements. In some aspects, the memory apparatus 210 may dynamically adapt or modify values for one or more thresholds in a similar manner (e.g., enabling the memory apparatus to adapt to changing use cases or performance requirements without explicit reconfiguration from the host system 205).

In some implementations, as shown by reference number 230, the host system 205 may determine that the write performance mode is to be enabled for the memory apparatus 210. For example, the host system 205 may configure the write performance mode for the memory apparatus 210 and may dynamically enable or disable the write performance mode. For example, if the write performance mode is enabled for the memory apparatus 210, then the memory apparatus 210 may operate in the write performance mode based on values of one or more performance parameters satisfying respective thresholds (e.g., configured via the configuration information), as described in more detail elsewhere herein. If the write performance mode is disabled for the memory apparatus 210, then the memory apparatus 210 may not operate in the write performance mode regardless of the values of one or more performance parameters.

The host system 205 may selectively enable or disable, during operation of the memory apparatus, the write performance mode of the memory apparatus based on one or more operational parameters of the host system. As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination. As used herein, “selectively” performing a first operation (e.g., enabling the write performance mode) or a second operation (e.g., disabling the write performance mode) means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

The host system 205 may determine that the write performance mode is to be enabled for the memory apparatus 210 based on the one or more operational parameters, which may be indicative of operation information of the host system 205 and/or of the memory apparatus 210. For example, the one or more operational parameters may include a battery level, a charging state, a type of application executing on the host system 205, a type of data to be provided by the host system 205 to be stored by the memory apparatus 210, and/or one or more remediation capabilities enabled for the host system 205, among other examples. For example, the host system 205 may enable the write performance mode based on the battery level (e.g., of the host system 205) satisfying a battery threshold. Alternatively, the host system 205 may disable the write performance mode based on the battery level not satisfying the battery threshold. For example, if the battery level is low, a risk of data loss caused by temporarily storing data in the temporary storage location 215 may be increased (e.g., because the data may be lost if power is lost while the data is stored in volatile memory, such as the temporary storage location 215). Therefore, the host system 205 may disable the write performance mode when the battery level is low.

As another example, the host system 205 may selectively enable or disable the write performance mode based on whether a battery of the host system 205 is currently being charged (e.g., because a risk of data loss due to a loss of power may be decreased when the battery is being charged). As another example, the host system may selectively enable or disable the write performance mode based on a type of application executing on the host system 205. For example, if the host system 205 determines that a benchmark application (e.g., an application configured to perform one or more benchmark tests) is executing on the host system 205, then the host system 205 may enable the write performance mode for the memory apparatus 210 (e.g., to improve performance of the memory apparatus 210 during the one or more benchmark tests). As another example, the host system 205 may disable the write performance mode based on the type of application being associated with high importance data.

The host system 205 may selectively enable or disable the write performance mode based on the type of data to be provided by the host system 205 to be stored by the memory apparatus 210. For example, if the type of data is associated with high importance (e.g., operating system update data), then the host system 205 may disable the write performance mode. For example, if the host system 205 determines that the host system is performing an operation associated with important data, such as an operating system update operation, then the host system 205 may disable the write performance mode (e.g., to ensure that the memory apparatus 210 is following any immediate write commands for the high importance data, such as an FUA command).

As another example, the host system 205 may selectively enable or disable the write performance mode based on one or more remediation capabilities enabled or configured for the host system 205. For example, if the one or more remediation capabilities are enabled or configured for the host system 205, then the host system 205 may enable the write performance mode. Alternatively, if the one or more remediation capabilities are not enabled or configured for the host system 205, then the host system 205 may disable the write performance mode. The one or more remediation capabilities may include a power loss tolerant file system, a redundant array of independent disks (RAID) configuration, a snapshot and backup system, one or more error correction codes, and/or a data replication system, among other examples. In some examples, the host system 205 may enable the one or more remediation capabilities based on enabling the write performance mode for the memory apparatus 210. For example, the host system 205 may use or enable one or more host-level remediation capabilities based on enabling the write performance mode for the memory apparatus 210. This may enable the host system 205 to recover any data that may be lost as a result of power loss for the memory apparatus 210, thereby mitigating a data loss risk that may otherwise be associated with the write performance mode.

In some aspects, as shown by reference number 235, the host system 205 may transmit, and the memory apparatus 210 may receive, an indication that the write performance mode is enabled. For example, the host system 205 may provide an indication that the write performance mode is enabled for the memory apparatus based on determining to enable the write performance mode (e.g., after providing the initial configuration of the write performance mode).

In some aspects, the host system 205 may not transmit the indication that the write performance mode is enabled. In such examples, the memory apparatus 210 may determine that the write performance mode is enabled based on receiving the configuration information. For example, the memory apparatus 210 may determine that the write performance mode is enabled unless the memory apparatus 210 receives an indication that the write performance mode is disabled.

Additionally, or alternatively, the indication for enabling the write performance mode may originate from a component of the host system 205 that performs automated system analysis to detect that the host system 205 is engaging in write-intensive tasks that would benefit from the memory apparatus 210 operating in the write performance mode. For example, a component (e.g., of the host system 205 or of the memory apparatus 210) may monitor the rate of write commands and, upon identifying a sudden and sustained increase in write request frequency that exceeds a given rate, automatically cause the wire performance mode to be enabled.

As shown by reference number 240, the memory apparatus 210 may monitor one or more performance parameters to determine whether to operate in the write performance mode or in a normal write mode. In the normal write mode, the memory apparatus 210 may honor or execute commands (e.g., from the host system 205) that indicate data is to be immediately written to the non-volatile memory location 220, such as FUA commands, and/or cache synchronization commands, among other examples. The memory apparatus 210 may continuously or periodically check value of one or more performance parameters, such as the number of write commands in the command queue, the amount or size of data to be written as indicated by one or more write commands in the command queue, and/or a bandwidth utilization for write operations, among other examples. For example, the memory apparatus may determine which write operation mode (e.g., the write performance mode or the normal write mode) to operate in based on the values of the one or more performance parameters. In some aspects, the memory apparatus 210 may calculate an instantaneous or average data transfer rate over a given amount of time, thereby enabling the memory apparatus 210 to discern whether the incoming data flow is indicative of standard operation or should cause the activation of the write performance mode.

Additionally, or alternatively, the memory apparatus 210 may consider account the type or source of the write commands when determining which write operation mode (e.g., the write performance mode or the normal write mode) to operate in. For example, the memory apparatus 210 may distinguish between write commands originating from user-initiated tasks and write commands originating from system maintenance operations, applying different thresholds or criteria for performance mode activation based on the type or source of the write commands.

As shown in FIG. 2B, and by reference number 245, the memory apparatus 210 may operate, based on the values of the one or more performance parameters, in the write performance mode. For example, the memory apparatus 210 may determine that the values satisfy respective thresholds (e.g., where the threshold(s) are indicated by the configuration information). In some aspects, the memory apparatus 210 may switch to or activate the write performance mode based on an amount of time for which the values satisfy the respective thresholds. For example, the memory apparatus 210 may switch to or activate the write performance mode based on the amount of time satisfying a time threshold (e.g., to reduce a likelihood of the memory apparatus 210 frequently switching write performance modes when values of the one or more performance parameters are close to values of the one or more thresholds).

In other words, after the memory apparatus 210 determines that the operational demands are high enough (e.g., as indicated by the one or more performance parameters satisfying the respective thresholds) the memory apparatus 210 may transition to the write performance mode (e.g., from the normal write mode) to optimize performance. For example, the normal write mode may be a default write operation mode for the memory apparatus 210. In some aspects, the memory apparatus 210 operating in the write performance mode may enable enhanced command completion times and/or energy efficiency of the memory apparatus 210 by optimizing the power consumption associated with data transfers and write operations during periods of elevated throughput. In some aspects, while operating in the write performance mode, the memory apparatus 210 may employ dynamic wear-leveling techniques that prioritize usage of memory cells due to be refreshed or rewritten, thus potentially extending the operational lifespan of the non-volatile memory cells (e.g., in the non-volatile memory location 220) during periods of high-demand data traffic.

As shown by reference number 250, the host system 205 may transmit, and the memory apparatus 210 may receive, a command with an immediate write indication. As used herein, an “immediate write indication” may refer to an indication that data is to be directly written to non-volatile memory (e.g., the non-volatile memory location 220) rather than being temporarily stored in volatile memory (e.g., the temporary storage location 215). For example, the command may indicate that data is to be immediately written to the non-volatile memory location 220 associated with the memory apparatus 210. In some examples, the command may be a write command with an FUA command (e.g., indicating that data indicated by the write command is to be written directly to the non-volatile memory location 220 rather than in the temporary storage location 215). As another example, the command may be a cache synchronization command (e.g., a sync cache command) indicating that any data stored in a write cache (e.g., the temporary storage location 215) is to be written to non-volatile memory (e.g., the non-volatile memory location 220).

As shown by reference number 255, the memory apparatus 210 may store the data (e.g., indicated by the command) in the temporary storage location 215 based on operating in the write performance mode. For example, the memory apparatus 210 may refrain from immediately writing the data to a physical storage location (e.g., to the non-volatile memory location 220). For example, the memory apparatus 210 may temporarily retain the data within a volatile write cache (e.g., in the temporary storage location 215). In other words, the memory apparatus 210 may temporarily ignore, defer, or delay the immediate write indication associated with the data (e.g., for processing during lower-demand conditions).

In an example where the command is a write command with the FUA command, the memory apparatus 210 may store the data indicated by the write command in the temporary storage location 215. In an example where the command is a cache synchronization command, the memory apparatus may maintain the data in the temporary storage location 215 and mark the data as being associated with an immediate write indication (e.g., via a flag for future processing when the memory apparatus 210 is no longer operating in the write performance mode).

For example, the memory apparatus 210 may mark the command as complete for expedited processing based on storing the data in the temporary storage location 215. The memory apparatus 210 may set a flag associated with the data stored in the temporary storage location 215 based on the command including the immediate write indication. For example, the flag may indicate that the data is associated with an immediate write indication. This may enable the memory apparatus 210 to track and/or identify what data is to be written to the non-volatile memory location 220 after the memory apparatus 210 transitions out of the write performance mode (e.g., after the memory apparatus 210 switches to the normal write mode). In some aspects, the memory apparatus 210 may perform one or more data protection operations for the data (e.g., to mitigate the risk of data loss caused by potential power loss scenarios), such as one or more power loss protection operations (e.g., via one or more capacitors and/or one or more power loss firmware algorithms), among other examples. For example, the memory apparatus 210 may selectively employ temporary error correction coding for data deemed at higher risk based on being associated with the flag and/or may store the data specific buffer regions of the temporary storage location with enhanced resilience to power fluctuations, among other examples.

Additionally, or alternatively, the memory apparatus 210 may use a tagging or categorization system to track such commands. For example, the memory apparatus 210 may append metadata to the command or associated data to facilitate subsequent processing steps and ensure the memory apparatus 210 can later fulfill any requirements imposed by the immediate write indication, such as after the memory apparatus 210 is no longer operating in the write performance mode.

As shown by reference number 260, the memory apparatus 210 may transmit, and the host system 205 may receive, an indication that the command has been completed while the data is stored in the temporary storage location 215. For example, the memory apparatus 210 may communicate to the host system 205 that the command has been completed after the data is stored in the temporary storage location 215 (e.g., even though the data has not yet been written to the non-volatile memory location 220 as requested by the immediate write indication). This operation differs from the typical write acknowledgment process (e.g., in which the memory apparatus 210 would not acknowledge the completion of the command until the data is written to the non-volatile memory location 220), thereby optimizing interaction speeds while the memory apparatus 210 is operating in the write performance mode. For example, the host system 205 may receive the indication that the command has been completed and may determine that the data is written to the non-volatile memory location 220. This may enable the host system 205 to move on to performing one or more other operations, thereby improve performance of the host system 205 (and/or the system 100) because the latency or delay associated with the host system 205 receiving the acknowledgment that the command is completed may be reduced.

In some aspects, as shown by reference number 265, the host system 205 may determine that the write performance mode is to be disabled for the memory apparatus 210. For example, the host system 205 may selectively disable, during operation of the memory apparatus, the write performance mode of the memory apparatus based on the one or more operational parameters of the host system 205. The host system 205 may determine that the write performance mode is to be disabled for the memory apparatus 210 based on the one or more operational parameters. For example, as described elsewhere herein, the one or more operational parameters may include a battery level, a charging state, a type of application executing on the host system 205, a type of data to be provided by the host system 205 to be stored by the memory apparatus 210, and/or one or more remediation capabilities enabled for the host system 205, among other examples. For example, the host system 205 may disable the write performance mode based on the battery level (e.g., of the host system 205) not satisfying the battery threshold. For example, if the battery level is low, a risk of data loss caused by temporarily storing data in the temporary storage location 215 may be increased (e.g., because the data may be lost if power is lost while the data is stored in volatile memory, such as the temporary storage location 215). Therefore, the host system 205 may disable the write performance mode when the battery level is low.

As another example, the host system 205 may disable the write performance mode based on a type of application executing on the host system 205. For example, if the host system 205 determines that an application (e.g., an application configured to perform one or more benchmark tests) is executing on the host system 205 that is associated with high priority, then the host system 205 may disable the write performance mode for the memory apparatus 210 (e.g., to reduce the likelihood of data loss for the application). The host system 205 may disable the write performance mode based on the type of data to be provided by the host system 205 to be stored by the memory apparatus 210. For example, if the type of data is associated with high importance (e.g., operating system update data), then the host system 205 may disable the write performance mode. For example, if the host system 205 determines that the host system is performing an operation associated with important data, such as an operating system update operation, then the host system 205 may disable the write performance mode (e.g., to ensure that the memory apparatus 210 is following any immediate write commands for the high importance data, such as an FUA command).

In some aspects, if the host system 205 disables the write performance mode for the memory apparatus 210, then the host system 205 may disable one or more remediation operations performed by the host system, such as the use of a power loss tolerant file system, a RAID configuration, a snapshot and backup system, one or more error correction codes, and/or a data replication system, among other examples. This may conserve power and/or processing resources that would have otherwise been associated with performing the disable one or more remediation operations when the write performance mode is disabled for the memory apparatus 210.

In some aspects, as shown by reference number 270, the host system 205 may transmit, and the memory apparatus 210 may receive, an indicating that the write performance mode is disabled for the memory apparatus 210. For example, if the host system 205 determines that the write performance mode is to be disabled, then the host system 205 may communicate with the memory apparatus 210 to cause the write performance mode to be disabled for the memory apparatus 210 (e.g., to be unavailable for use by the memory apparatus 210).

As shown in FIG. 2C, and by reference number 275, the memory apparatus 210 may operate in the normal write mode. For example, the memory apparatus 210 may switch for operating in the write performance mode to operating in the normal write mode. In some aspects, the memory apparatus 210 may switch to operating in the normal write mode based on receiving an indication from the host system 205 that the write performance mode is disabled. In such examples, the memory apparatus 210 may operate in the normal write mode regardless of values of the one or more performance parameters described herein.

Additionally, or alternatively, the memory apparatus 210 may operate in the normal write mode based on current values of the one or more performance parameters. For example, the memory apparatus 210 may determine that the current values no longer satisfy respective thresholds (e.g., indicated by the configuration information). In some aspects, the memory apparatus 210 may determine that the current values no longer satisfy respective thresholds for an amount of time. The memory apparatus 210 may switch to operating in the normal write mode based on the amount of time satisfying a threshold (e.g., the time threshold described elsewhere herein or another threshold).

For example, the memory apparatus 210 may switch from operating in the write performance to the normal write mode when the performance mode conditions are no longer met, indicating that the write performance mode should be deactivated (e.g., thus returning the memory apparatus 210 to standard write operation). In some aspects, switching to the normal write mode may include a staggered or controlled transition process designed to ensure that data integrity is preserved and system stability is maintained. For example, the memory apparatus 210 may implement a gradual clearing of the temporary storage location 215, synchronizing this temporary storage location 215 clearance with a decrease in the write demand from the host system 205, thereby avoiding sudden disruptions in the data flow.

Additionally, or alternatively, the switch to the normal write mode may include the memory apparatus 210 performing a check and/or confirmation of data flagged for immediate write based on the flag(s) set by the memory apparatus 210 while the memory apparatus 210 was operating in the write performance mode. For example, the memory apparatus 210 may identify data to be written to the non-volatile memory location 220 while the memory apparatus 210 is operating in the normal write mode. This ensures that any pending write commands with an immediate write indication are now honored and moved to non-volatile storage in line with the standard protocol expectations of the host system 205. For example, the memory apparatus 210 may write the data from the temporary storage location 215 (e.g., that is flagged as being associated with an immediate write indication) to the non-volatile memory location 220 after switching operation to the normal write mode. For example, the memory apparatus 210 may prioritize writing the data from the temporary storage location 215 to the non-volatile memory location 220 based on the data being flagged as being associated with an immediate write indication (e.g., writing the flagged data may be prioritized over writing other data in the temporary storage location 215 that is not flagged as being associated with an immediate write indication).

In some aspects, as shown by reference number 280, the host system 205 may transmit, and the memory apparatus may receive, a write command. The write command may prompt further progress in write operations of the memory apparatus 210. For example, the receipt of the write command may provide an opportunity for the memory apparatus 210 to reevaluate its operational mode in real-time, leveraging the latest command as a sample of ongoing host activity. Additionally, or alternatively, the memory apparatus 210 may use the receipt of the write command as a triggers to conduct an assessment of the status of the temporary storage location 215, ensuring that the command queue and pending data commitments are being handled optimally as the memory apparatus 210 switches operational write modes. For example, the receipt of the write command may provide an opportunity for the memory apparatus to write flagged data from the temporary storage location 215 to the non-volatile memory location 220.

As shown by reference number 285, the memory apparatus 210 may write data (e.g., that is associated with an immediate write indication) from the temporary storage location 215 to the non-volatile memory location 220. For example, the memory apparatus 210 may commit data to the non-volatile memory location 220, such as NAND flash memory, as part of concluding write commands according to write procedures associated with the immediate write indication (e.g., to ensure data persistence). For example, the memory apparatus 210 may write, while operating in the normal write mode, the data from the temporary storage location 215 to the non-volatile memory location 220. For example, the data may be data that was associated with an immediate write indication previously received by the memory apparatus 210 while the memory apparatus 210 was operating in the write performance mode. For example, the memory apparatus 210 may identify the data in the temporary storage location 215 based on the flags, as described in more detail elsewhere herein. Writing the data to the non-volatile memory location 220 may complete the write cycle for the data, thereby ensuring that the data has been securely stored and that the storage state of the data aligns with expectations of the host system 205.

For example, the memory apparatus 210 may detect, after transmitting the indication that the command has been completed, that the data is to be written from the temporary storage location 215 to the non-volatile memory location 220. For example, the memory apparatus 210 may detect that the data is to be written to the non-volatile memory location 220 based on operating in the normal write mode (e.g., based on the write performance mode being disabled by the host system 205 and/or based on current values of the one or more performance parameters). Additionally, or alternatively, the memory apparatus 210 may detect that the data is to be written to the non-volatile memory location 220 based on receiving a write command after switching from operating in the write performance mode to operating in the normal write mode. The memory apparatus 210 may write, based on detecting that the data is to be written from the temporary storage location 215 to the non-volatile memory location 220, the data from the temporary storage location 215 to the non-volatile memory location 220.

In some aspects, the memory apparatus 210 may be unable to write data (e.g., associated with a flag indicating that is data is associated with an immediate write indication) to the non-volatile memory location 220, such as due to power loss or other write operation failures. In such examples, the memory apparatus 210 may transmit, and the host system 205 may receive, an indication that the data is not stored in the non-volatile memory location 220. This may enable the host system 205 to provide the data again for storage by the memory apparatus and/or to enable the host system 205 to perform one or more remediation operations to recover the data.

Additionally, or alternatively, the writing of the data may include a consolidation phase in which the memory apparatus 210 consolidates or merges one or more data blocks, from the temporary storage location 215, into larger contiguous blocks. This may enhance the efficiency of write operations to the non-volatile memory location 220. For example, the consolidation of data blocks may optimize utilization of the non-volatile memory and/or increase a lifespan of the non-volatile memory by reducing the frequency of write cycles and evenly distributing write operations across the non-volatile memory location 220.

As indicated above, FIGS. 2A-2C are provided as an example. Other examples may differ from what is described with regard to FIGS. 2A-2C.

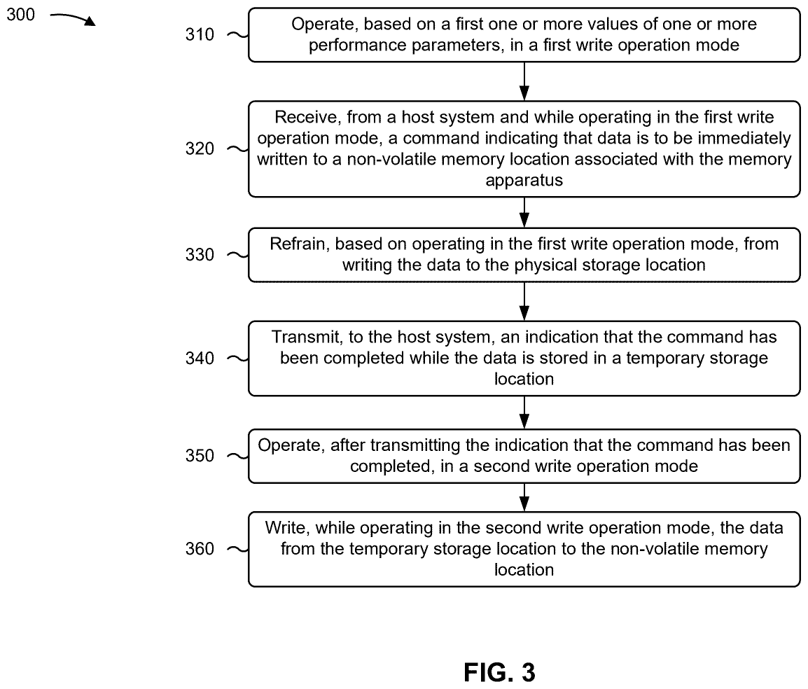

FIG. 3 is a flowchart of an example method 300 associated with a performance mode for write operations. In some implementations, a memory apparatus (e.g., the memory apparatus 210) may perform or may be configured to perform the method 300. In some implementations, another device or a group of devices separate from or including the memory apparatus (e.g., the host system 205, the system 100, the host system 105, the host processor 150, the memory system 110, the memory system controller 115, one or more memory devices 120, and/or one or more local controllers 125) may perform or may be configured to perform the method 300. Additionally, or alternatively, one or more components of the memory apparatus (e.g., the memory system controller 115, a local controller 125, a volatile memory array 135, a memory array 130, the temporary storage location 215, and/or the non-volatile memory location 220) may perform or may be configured to perform the method 300. Thus, means for performing the method 300 may include the memory apparatus and/or one or more components of the memory apparatus. Additionally, or alternatively, a non-transitory computer-readable medium may store one or more instructions that, when executed by the memory apparatus, cause the memory apparatus to perform the method 300.

As shown in FIG. 3, the method 300 may include operating, based on a first one or more values of one or more performance parameters, in a first write operation mode (e.g., the write performance mode) (block 310). As further shown in FIG. 3, the method 300 may include receiving, from a host system and while operating in the first write operation mode, a command indicating that data is to be immediately written to a non-volatile memory location associated with the memory apparatus (block 320). As further shown in FIG. 3, the method 300 may include refraining, based on operating in the first write operation mode, from writing the data to the non-volatile memory location (block 330). As further shown in FIG. 3, the method 300 may include transmitting, to the host system, an indication that the command has been completed while the data is stored in a temporary storage location (block 340). As further shown in FIG. 3, the method 300 may include operating, after transmitting the indication that the command has been completed, in a second write operation mode (e.g., the normal write mode) (block 350). As further shown in FIG. 3, the method 300 may include writing, while operating in the second write operation mode, the data from the temporary storage location to the non-volatile memory location (block 360).

The method 300 may include additional aspects, such as any single aspect or any combination of aspects described below and/or described in connection with one or more other methods or operations described elsewhere herein.

In a first aspect, the method 300 includes storing, based on operating in the first write operation mode, the data in the temporary storage location.

In a second aspect, alone or in combination with the first aspect, the method 300 includes receiving, from the host system, configuration information for the first write operation mode, wherein the configuration information indicates one or more thresholds, and wherein operating in the first write operation mode includes detecting that the first one or more values satisfy respective thresholds of the one or more thresholds, and operating in the first write operation mode based on the first one or more values satisfying the respective thresholds.

In a third aspect, alone or in combination with one or more of the first and second aspects, the method 300 includes setting a flag associated with the data stored in the temporary storage location, wherein the flag indicates that the data is associated with an immediate write indication.

In a fourth aspect, alone or in combination with one or more of the first through third aspects, the method 300 includes receiving, from the host system and while operating in the second write operation mode, a write command, and writing the data from the temporary storage location to the non-volatile memory location based on receiving the write command and based on the data being associated with the flag.

In a fifth aspect, alone or in combination with one or more of the first through fourth aspects, the method 300 includes receiving, from the host system, an indication that the first write operation mode is enabled for the memory apparatus, and operating in the first write operation mode based on receiving the indication that the first write operation mode is enabled.

In a sixth aspect, alone or in combination with one or more of the first through fifth aspects, the method 300 includes receiving, from the host system, an indication that the first write operation mode is disabled for the memory apparatus, and operating in the second write operation mode based on receiving the indication that the first write operation mode is disabled.

In a seventh aspect, alone or in combination with one or more of the first through sixth aspects, the command includes a write command with a forced unit access indication indicating that the data is to be immediately written to the non-volatile memory location.

In an eighth aspect, alone or in combination with one or more of the first through seventh aspects, the data in the temporary storage location, and wherein the command includes a synchronize cache command indicating the data in the temporary storage location is to be immediately written to the non-volatile memory location.

In a ninth aspect, alone or in combination with one or more of the first through eighth aspects, the method 300 includes operating in the first write operation mode based on the first one or more values satisfying one or more thresholds, and wherein operating in the second write operation mode includes operating in the second write operation mode based on a second one or more values of the one or more performance parameters not satisfying the one or more thresholds.

In a tenth aspect, alone or in combination with one or more of the first through ninth aspects, the one or more performance parameters include at least one of a quantity of write commands in a command queue of the memory apparatus, a size of data associated with the write commands in the command queue, or a bandwidth utilization for write operations by the memory apparatus.

Although FIG. 3 shows example blocks of a method 300, in some implementations, the method 300 may include additional blocks, fewer blocks, different blocks, or differently arranged blocks than those depicted in FIG. 3. Additionally, or alternatively, two or more of the blocks of the method 300 may be performed in parallel. The method 300 is an example of one method that may be performed by one or more devices described herein. These one or more devices may perform or may be configured to perform one or more other methods based on operations described herein.

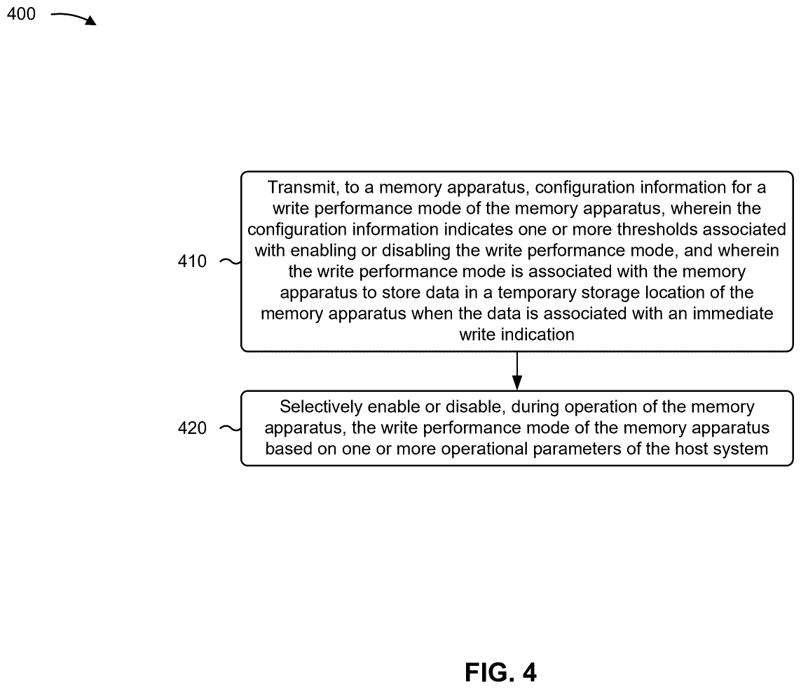

FIG. 4 is a flowchart of an example method 400 associated with a performance mode for write operations. In some implementations, a host system (e.g., the host system 205 and/or the host system 105) may perform or may be configured to perform the method 400. In some implementations, another device or a group of devices separate from or including the host system (e.g., the memory apparatus 210, the memory system 110, the memory system controller 115, one or more memory devices 120, and/or one or more local controllers 125) may perform or may be configured to perform the method 400. Additionally, or alternatively, one or more components of the host system (e.g., the host processor 150) may perform or may be configured to perform the method 400. Thus, means for performing the method 400 may include the host system and/or one or more components of the host system. Additionally, or alternatively, a non-transitory computer-readable medium may store one or more instructions that, when executed by the host system, cause the host system to perform the method 400.

As shown in FIG. 4, the method 400 may include transmitting, to a memory apparatus, configuration information for a write performance mode of the memory apparatus, wherein the configuration information indicates one or more thresholds associated with enabling or disabling the write performance mode, and wherein the write performance mode is associated with the memory apparatus to store data in a temporary storage location of the memory apparatus when the data is associated with an immediate write indication (block 410). As further shown in FIG. 4, the method 400 may include selectively enabling or disable, during operation of the memory apparatus, the write performance mode of the memory apparatus based on one or more operational parameters of the host system (block 420).

The method 400 may include additional aspects, such as any single aspect or any combination of aspects described below and/or described in connection with one or more other methods or operations described elsewhere herein.

In a first aspect, the one or more thresholds are associated with respective performance parameters of one or more performance parameters for the memory apparatus, and wherein the one or more performance parameters include at least one of a quantity of write commands in a command queue of the memory apparatus, a size of data associated with the write commands in the command queue, or a bandwidth utilization for write operations by the memory apparatus.

In a second aspect, alone or in combination with the first aspect, the method 400 includes transmitting, to the memory apparatus, a command indicating whether the write performance mode is enabled or disabled.

In a third aspect, alone or in combination with one or more of the first and second aspects, the method 400 includes enabling the write performance mode based on the battery level satisfying a battery threshold, or disabling the write performance mode based on the battery level not satisfying the battery threshold.

In a fourth aspect, alone or in combination with one or more of the first through third aspects, the one or more operational parameters include a type of application executing on the host system.

In a fifth aspect, alone or in combination with one or more of the first through fourth aspects, the one or more operational parameters include a type of data to be provided by the host system to be stored by the memory apparatus.

In a sixth aspect, alone or in combination with one or more of the first through fifth aspects, the one or more operational parameters include one or more remediation capabilities enabled for the host system.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

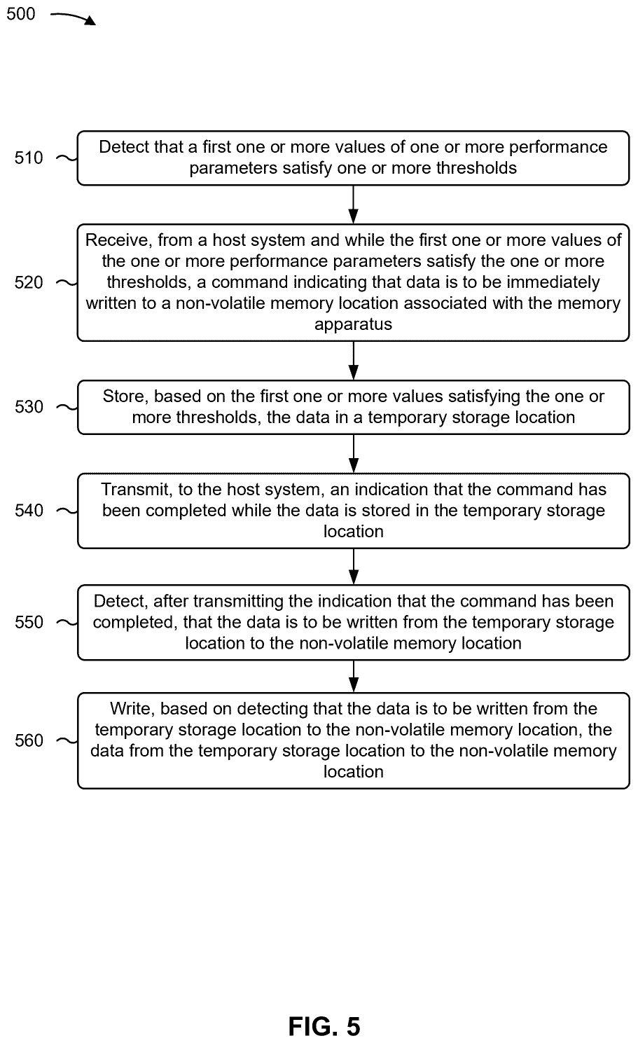

FIG. 5 is a flowchart of an example method 500 associated with a performance mode for write operations. In some implementations, a memory apparatus (e.g., the memory apparatus 210) may perform or may be configured to perform the method 500. In some implementations, another device or a group of devices separate from or including the memory apparatus (e.g., the host system 205, the system 100, the host system 105, the host processor 150, the memory system 110, the memory system controller 115, one or more memory devices 120, and/or one or more local controllers 125) may perform or may be configured to perform the method 500. Additionally, or alternatively, one or more components of the memory apparatus (e.g., the memory system controller 115, a local controller 125, a volatile memory array 135, a memory array 130, the temporary storage location 215, and/or the non-volatile memory location 220) may perform or may be configured to perform the method 500. Thus, means for performing the method 500 may include the memory apparatus and/or one or more components of the memory apparatus. Additionally, or alternatively, a non-transitory computer-readable medium may store one or more instructions that, when executed by the memory apparatus, cause the memory apparatus to perform the method 500.

As shown in FIG. 5, the method 500 may include detecting that a first one or more values of one or more performance parameters satisfy one or more thresholds (block 510). As further shown in FIG. 5, the method 500 may include receiving, from a host system and while the first one or more values of the one or more performance parameters satisfy the one or more thresholds, a command indicating that data is to be immediately written to a non-volatile memory location associated with the memory apparatus (block 520). As further shown in FIG. 5, the method 500 may include storing, based on the first one or more values satisfying the one or more thresholds, the data in a temporary storage location (block 530). As further shown in FIG. 5, the method 500 may include transmitting, to the host system, an indication that the command has been completed while the data is stored in the temporary storage location (block 540). As further shown in FIG. 5, the method 500 may include detecting, after transmitting the indication that the command has been completed, that the data is to be written from the temporary storage location to the non-volatile memory location (block 550). As further shown in FIG. 5, the method 500 may include writing, based on detecting that the data is to be written from the temporary storage location to the non-volatile memory location, the data from the temporary storage location to the non-volatile memory location (block 560).

The method 500 may include additional aspects, such as any single aspect or any combination of aspects described below and/or described in connection with one or more other methods or operations described elsewhere herein.

In a first aspect, the method 500 includes operating, based on detecting that the first one or more values satisfy the one or more thresholds, in a first write operation mode, and operating, based on detecting that the data is to be written from the temporary storage location to the non-volatile memory location, in a second write operation mode.

In a second aspect, alone or in combination with the first aspect, the method 500 includes receiving, from the host system, an indication that the first write operation mode is enabled for the memory apparatus, and wherein operating in the first write operation mode is based on the first write operation mode being enabled.

In a third aspect, alone or in combination with one or more of the first and second aspects, detecting that the data is to be written from the temporary storage location to the non-volatile memory location comprises at least one of detecting that a second one or more values of the one or more performance parameters do not satisfy the one or more thresholds, or receiving, from the host system, an indication that a write performance mode is disabled for the memory apparatus.

In a fourth aspect, alone or in combination with one or more of the first through third aspects, detecting that the first one or more values satisfy the one or more thresholds comprises detecting that an amount of time for which the first one or more values satisfy the one or more thresholds satisfies a time threshold, and wherein storing the data in the temporary storage location is based on the amount of time satisfying the time threshold.

In a fifth aspect, alone or in combination with one or more of the first through fourth aspects, the one or more performance parameters are associated with a command queue of the memory apparatus, and wherein the one or more thresholds are a function of a size of the command queue.

In a sixth aspect, alone or in combination with one or more of the first through fifth aspects, the method 500 includes receiving, from the host system, values for respective thresholds of the one or more thresholds.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

In some aspects, a memory apparatus includes one or more controllers configured to: operate, based on a first one or more values of one or more performance parameters, in a first write operation mode; receive, from a host system and while operating in the first write operation mode, a command indicating that data is to be immediately written to a non-volatile memory location associated with the memory apparatus; refrain, based on operating in the first write operation mode, from writing the data to the non-volatile memory location; transmit, to the host system, an indication that the command has been completed while the data is stored in a temporary storage location; operate, after transmitting the indication that the command has been completed, in a second write operation mode; and write, while operating in the second write operation mode, the data from the temporary storage location to the non-volatile memory location.

In some aspects, a host system includes one or more controllers configured to: transmit, to a memory apparatus, configuration information for a write performance mode of the memory apparatus, wherein the configuration information indicates one or more thresholds associated with enabling or disabling the write performance mode, and wherein the write performance mode is associated with the memory apparatus to store data in a temporary storage location of the memory apparatus when the data is associated with an immediate write indication; and selectively enable or disable, during operation of the memory apparatus, the write performance mode of the memory apparatus based on one or more operational parameters of the host system.

In some aspects, a method includes detecting, by a memory apparatus, that a first one or more values of one or more performance parameters satisfy one or more thresholds; receiving, by the memory apparatus and from a host system and while the first one or more values of the one or more performance parameters satisfy the one or more thresholds, a command indicating that data is to be immediately written to a non-volatile memory location associated with the memory apparatus; storing, by the memory apparatus and based on the first one or more values satisfying the one or more thresholds, the data in a temporary storage location; transmitting, by the memory apparatus and to the host system, an indication that the command has been completed while the data is stored in the temporary storage location; detecting, by the memory apparatus and after transmitting the indication that the command has been completed, that the data is to be written from the temporary storage location to the non-volatile memory location; and writing, by the memory apparatus and based on detecting that the data is to be written from the temporary storage location to the non-volatile memory location, the data from the temporary storage location to the non-volatile memory location.

In some aspects, a method includes operating, by a memory apparatus and based on a first one or more values of one or more performance parameters, in a first write operation mode; receiving, by the memory apparatus and from a host system and while operating in the first write operation mode, a command indicating that data is to be immediately written to a non-volatile memory location associated with the memory apparatus; refraining, by the memory apparatus based on operating in the first write operation mode, from writing the data to the non-volatile memory location; transmitting, by the memory apparatus and to the host system, an indication that the command has been completed while the data is stored in a temporary storage location; operating, by the memory apparatus after transmitting the indication that the command has been completed, in a second write operation mode; and writing, by the memory apparatus and while operating in the second write operation mode, the data from the temporary storage location to the non-volatile memory location.

In some aspects, a method includes transmitting, by a host system and to a memory apparatus, configuration information for a write performance mode of the memory apparatus, wherein the configuration information indicates one or more thresholds associated with enabling or disabling the write performance mode, and wherein the write performance mode is associated with the memory apparatus to store data in a temporary storage location of the memory apparatus when the data is associated with an immediate write indication; and selectively enabling or disabling, by the host system and during operation of the memory apparatus, the write performance mode of the memory apparatus based on one or more operational parameters of the host system.

In some aspects, a system includes a host system; and a memory apparatus, configured to: operate, based on a first one or more values of one or more performance parameters, in a first write operation mode; receive, from the host system and while operating in the first write operation mode, a command indicating that data is to be immediately written to a non-volatile memory location associated with the memory apparatus; refrain, based on operating in the first write operation mode, from writing the data to the non-volatile memory location; transmit, to the host system, an indication that the command has been completed while the data is stored in a temporary storage location; operate, after transmitting the indication that the command has been completed, in a second write operation mode; and write, while operating in the second write operation mode, the data from the temporary storage location to the non-volatile memory location.

In some aspects, an apparatus includes means for detecting that a first one or more values of one or more performance parameters satisfy one or more thresholds; means for receiving, from a host system and while the first one or more values of the one or more performance parameters satisfy the one or more thresholds, a command indicating that data is to be immediately written to a non-volatile memory location associated with the memory apparatus; means for storing, based on the first one or more values satisfying the one or more thresholds, the data in a temporary storage location; means for transmitting, to the host system, an indication that the command has been completed while the data is stored in the temporary storage location; means for detecting, after transmitting the indication that the command has been completed, that the data is to be written from the temporary storage location to the non-volatile memory location; and means for writing, based on detecting that the data is to be written from the temporary storage location to the non-volatile memory location, the data from the temporary storage location to the non-volatile memory location.

In some aspects, an apparatus includes means for operating, based on a first one or more values of one or more performance parameters, in a first write operation mode; means for receiving, from a host system and while operating in the first write operation mode, a command indicating that data is to be immediately written to a non-volatile memory location associated with the memory apparatus; means for refraining from writing the data to the non-volatile memory location; means for transmitting, to the host system, an indication that the command has been completed while the data is stored in a temporary storage location; means for operating in a second write operation mode; and means for writing, while operating in the second write operation mode, the data from the temporary storage location to the non-volatile memory location.

In some aspects, an apparatus includes means for transmitting, to a memory apparatus, configuration information for a write performance mode of the memory apparatus, wherein the configuration information indicates one or more thresholds associated with enabling or disabling the write performance mode, and wherein the write performance mode is associated with the memory apparatus to store data in a temporary storage location of the memory apparatus when the data is associated with an immediate write indication; and means for selectively enabling, during operation of the memory apparatus, or disabling the write performance mode of the memory apparatus based on one or more operational parameters of the host system.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory apparatus, comprising:
one or more controllers configured to:
operate, based on a first one or more values of one or more performance parameters, in a first write operation mode;
receive, from a host system and while operating in the first write operation mode, a command indicating that data is to be immediately written to a non-volatile memory location associated with the memory apparatus;
refrain, based on operating in the first write operation mode, from writing the data to the non-volatile memory location;
transmit, to the host system, an indication that the command has been completed while the data is stored in a temporary storage location;
operate, after transmitting the indication that the command has been completed, in a second write operation mode; and
write, while operating in the second write operation mode, the data from the temporary storage location to the non-volatile memory location.

2. The memory apparatus of claim 1, wherein the command is a write command indicating the data, and wherein the one or more controllers are further configured to:
store, based on operating in the first write operation mode, the data in the temporary storage location.

3. The memory apparatus of claim 1, wherein the one or more controllers are further configured to:
receive, from the host system, configuration information for the first write operation mode, wherein the configuration information indicates one or more thresholds, and
wherein the one or more controllers, to operate in the first write operation mode, are configured to:
detect that the first one or more values satisfy respective thresholds of the one or more thresholds; and
operate in the first write operation mode based on the first one or more values satisfying the respective thresholds.

4. The memory apparatus of claim 1, wherein the one or more controllers are further configured to:
set a flag associated with the data stored in the temporary storage location, wherein the flag indicates that the data is associated with an immediate write indication.

5. The memory apparatus of claim 4, wherein the one or more controllers, to write the data from the temporary storage location to the non-volatile memory location, are configured to:
receive, from the host system and while operating in the second write operation mode, a write command; and
write the data from the temporary storage location to the non-volatile memory location based on receiving the write command and based on the data being associated with the flag.

6. The memory apparatus of claim 1, wherein the one or more controllers, to operate in the first write operation mode, are configured to:
receive, from the host system, an indication that the first write operation mode is enabled for the memory apparatus; and
operate in the first write operation mode based on receiving the indication that the first write operation mode is enabled.

7. The memory apparatus of claim 1, wherein the one or more controllers, to operate in the second write operation mode, are configured to:
receive, from the host system, an indication that the first write operation mode is disabled for the memory apparatus; and
operate in the second write operation mode based on receiving the indication that the first write operation mode is disabled.

8. The memory apparatus of claim 1, wherein the command includes a write command with a forced unit access indication indicating that the data is to be immediately written to the non-volatile memory location.

9. The memory apparatus of claim 1, wherein the data in the temporary storage location, and wherein the command includes a synchronize cache command indicating the data in the temporary storage location is to be immediately written to the non-volatile memory location.

10. The memory apparatus of claim 1, wherein the one or more controllers, to operate in the first write operation mode, are configured to:
operate in the first write operation mode based on the first one or more values satisfying one or more thresholds, and
wherein the one or more controllers, to operate in the second write operation mode, are configured to:
operate in the second write operation mode based on a second one or more values of the one or more performance parameters not satisfying the one or more thresholds.

11. The memory apparatus of claim 1, wherein the one or more performance parameters include at least one of:
a quantity of write commands in a command queue of the memory apparatus,
a size of data associated with the write commands in the command queue, or
a bandwidth utilization for write operations by the memory apparatus.

12. A host system, comprising:
one or more controllers configured to:
transmit, to a memory apparatus, configuration information for a write performance mode of the memory apparatus,
wherein the configuration information indicates one or more thresholds associated with enabling or disabling the write performance mode, and
wherein the write performance mode is associated with the memory apparatus to store data in a temporary storage location of the memory apparatus when the data is associated with an immediate write indication; and
selectively enable or disable, during operation of the memory apparatus, the write performance mode of the memory apparatus based on one or more operational parameters of the host system.

13. The host system of claim 12, wherein the one or more thresholds are associated with respective performance parameters of one or more performance parameters for the memory apparatus, and wherein the one or more performance parameters include at least one of:
a quantity of write commands in a command queue of the memory apparatus,
a size of data associated with the write commands in the command queue, or
a bandwidth utilization for write operations by the memory apparatus.

14. The host system of claim 12, wherein the one or more controllers, to selectively enable or disable the write performance mode of the memory apparatus, are configured to:
transmit, to the memory apparatus, a command indicating whether the write performance mode is enabled or disabled.

15. The host system of claim 12, wherein the one or more operational parameters include a battery level, and wherein the one or more controllers, to selectively enable or disable the write performance mode of the memory apparatus, are configured to:
enable the write performance mode based on the battery level satisfying a battery threshold; or
disable the write performance mode based on the battery level not satisfying the battery threshold.

16. The host system of claim 12, wherein the one or more operational parameters include a type of application executing on the host system.

17. The host system of claim 12, wherein the one or more operational parameters include a type of data to be provided by the host system to be stored by the memory apparatus.

18. The host system of claim 12, wherein the one or more operational parameters include one or more remediation capabilities enabled for the host system.

19. A method, comprising:
detecting, by a memory apparatus, that a first one or more values of one or more performance parameters satisfy one or more thresholds;
receiving, by the memory apparatus and from a host system and while the first one or more values of the one or more performance parameters satisfy the one or more thresholds, a command indicating that data is to be immediately written to a non-volatile memory location associated with the memory apparatus;
storing, by the memory apparatus and based on the first one or more values satisfying the one or more thresholds, the data in a temporary storage location;
transmitting, by the memory apparatus and to the host system, an indication that the command has been completed while the data is stored in the temporary storage location;
detecting, by the memory apparatus and after transmitting the indication that the command has been completed, that the data is to be written from the temporary storage location to the non-volatile memory location; and
writing, by the memory apparatus and based on detecting that the data is to be written from the temporary storage location to the non-volatile memory location, the data from the temporary storage location to the non-volatile memory location.

20. The method of claim 19, further comprising:
operating, based on detecting that the first one or more values satisfy the one or more thresholds, in a first write operation mode; and
operating, based on detecting that the data is to be written from the temporary storage location to the non-volatile memory location, in a second write operation mode.

21. The method of claim 20, further comprising:
receiving, from the host system, an indication that the first write operation mode is enabled for the memory apparatus, and
wherein operating in the first write operation mode is based on the first write operation mode being enabled.

22. The method of claim 19, wherein detecting that the data is to be written from the temporary storage location to the non-volatile memory location comprises at least one of:
detecting that a second one or more values of the one or more performance parameters do not satisfy the one or more thresholds, or
receiving, from the host system, an indication that a write performance mode is disabled for the memory apparatus.

23. The method of claim 19, wherein detecting that the first one or more values satisfy the one or more thresholds comprises:
detecting that an amount of time for which the first one or more values satisfy the one or more thresholds satisfies a time threshold, and
wherein storing the data in the temporary storage location is based on the amount of time satisfying the time threshold.

24. The method of claim 19, wherein the one or more performance parameters are associated with a command queue of the memory apparatus, and
wherein the one or more thresholds are a function of a size of the command queue.

25. The method of claim 19, further comprising:
receiving, from the host system, values for respective thresholds of the one or more thresholds.
